(19) United States
(12) Patent Application Publication
(10) Pub. No.: US 2019/0191237 A1
(43) Pub. Date: Jun. 20, 2019

(54) Headphone Apparatus with Two Separated Acoustic Chambers

(71) Applicant: Xiaopeng Wang, San Jose, CA (US)

(72) Inventor: Xiaopeng Wang, San Jose, CA (US)

(21) Appl. No.: 15/970,853

(22) Filed: May 3, 2018

Related U.S. Application Data
(60) Provisional application No. 62/630,819, filed on Feb. 14, 2018.

(30) Foreign Application Priority Data
Dec. 20, 2017 (CN) 201711385613.1

(51) Int. Cl. H04R 1/10; G10K 11/178; H04R 7/02

(52) U.S. Cl. CPC H04R 1/1083; H04R 1/1008; G10K 2210/1081; H04R 7/02; G10K 11/178

(57) ABSTRACT

An apparatus including a noise acoustical chamber implement and an audio acoustical chamber implement. Said noise acoustical chamber is a generally sealed space to form first-stage passive noise reduction (PNR), wherein first vibratable diaphragms are disposed and first-stage active noise cancellation (ANC) signal processing are further implemented to reduce noise. Said audio acoustical chamber is another generally sealed space around eardrum and is enclosed by said noise acoustical chamber. Said audio acoustical chamber forms second-stage PNR, wherein second vibratable diaphragms are disposed to only generate sound wave of audio signal or at the same time utilize second-stage ANC signal processing to further reduce noise in said audio acoustical chamber.

### CROSS- REFERENCE TO RELATED APPLICATIONS

The present Utility patent application claims priority benefit of the U.S. provisional application for patent serial number 62630819 entitled “Active Noise Cancellation Headphone”, filed on Feb. 14, 2018, under 35 U.S.C. 119(e). The contents of this related provisional application are incorporated herein by reference for all purposes to the extent that such subject matter is not inconsistent herewith or limiting hereof. The present Utility patent application also claims priority benefit under 35 U.S.C. 119(a) of the Chinese patent 201711385613.1 filed on Dec. 20. 2017.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to headphones. More particularly, certain embodiments of the invention relate to headphone noise cancellation using active and passive noise cancellation.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

As portable media players shrink in size and are integrated into more devices such as phones and watches, they are typically used more regularly. This allows consumers to listen to music, audiobooks, discussions, TV shows and more in a wide variety of environments. When the surroundings are noisy, a user may decide to simply turn up the volume to try to listen more clearly. This may end up harming a user's hearing and still not allow them to listen clearly. Some headphones have tried to add a type of foam-like padding encircling the user's ear where the headphone speaker may be placed in order to insulate a user's ear from the outside noise. Other solutions may involve using active noise cancellation. While these solutions have helped block some noise, they typically do not block all of the noise and their effectiveness may vary in different environments.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

FIG. 1 illustrates prior art showing the conceptual architecture of a headphone with the use of active noise cancellation (ANC). An audio receiver 110 or an ANC processor 115 may typically be deployed inside or outside of a headphone external structure 120. The audio receiver 110 receives audio signal 180 from audio player source like phone or portable audio player via audio cable or wireless signal transmission. An acoustic chamber 105 commonly exists as a sealed space constructed by the headphone external structure 120 around people eardrum 140, in which an audio speaker 125 may be driven by the ANC processor 115 to generate sound wave and the sound wave propagates to the people eardrum 140. Since the headphone external structure 120 separates the acoustic chamber 105 from the environment, it generally contributes to a function of passive noise reduction (PNR) and environmental noise 145 will be downgraded in loudness level to a weakened noise 150 after it penetrates the headphone external structure 120. The first microphone 130 typically picks up environmental noise 145 and converts the noise into a feedforward type electrical signal (FF) 170, while the second microphone 135 typically picks up sound in the acoustic chamber 105 and converts the sound into a feedback type electrical signal (FB) 175. The first microphone 130 and FF 170 commonly might not be present in the ANC headphone depending on complexity of the ANC, as with the second microphone 135 and FB 175. The FF 170, FB 175 and the audio signal 180 sent out from the audio receiver 110 usually comprise of three input signals of the ANC processor 115, in which ANC signal processing may be operated. The output signal of the ANC processor 115 drives audio speaker 125 and the audio speaker 125 typically complete an electro-acoustic conversion to generate both an ideal audio wave 160 and a theoretical same magnitude of a 180 degrees phase difference sound wave 155 (anti-150 noise) related to the weakened noise 150 in the acoustic chamber 105. Following the principle of waveform destructive interference, the anti-150 noise and the weakened noise 150 will typically cancel each other and residual noise 165 in the acoustic chamber will be zero. As a result, the people eardrum 140 usually only approaches the ideal audio wave 160 regenerated from the audio signal 180 sent out by audio receiver 110. However, commonly the said assumption is theoretical, and the story is different in practice. First, sound is a 3-dimensional wave and its propagation and attenuation are frequency dependent. On consideration of complex structure of headphone and comprehensive variation of people ear size and shape, solely adopting feed-forwards control to construct anti-150 noise based on FF 170 is of limited ANC performance. Second, ANC performance may improve after introducing into feed-back closed-loop control to construct anti-150 noise based on FB 175 or hybrid closed-loop control to construct anti-150 noise based on both FF 170 and FB 175. However, the second microphone 135 picks up not only the residual noise 165, but also the ideal audio wave 160. Thus, both the residual noise 165 and the ideal audio wave 160 are involved in the feedback loop process by the ANC processor 115 when implementing ANC, wherein non-ideal ANC controller may modify the content of the audio signal to make the ideal audio wave 160 a ANC distorted regeneration of the audio signal 180. In order to compensate the distortion of the audio signal after ANC process, acoustic equalizer (EQ) is commonly further utilized in many products in different forms. One disadvantage of the EQ process is that generally audio signature of the headphone becomes different when ANC is enabled or not. Another disadvantage is commonly the design complexity of the said EQ process, wherein audio quality of the headphone after the ANC EQ compensation may not be as good as that of a high-performance headphone. Third, there are a lot of challenges and physics limitation restraining the performance of ANC controller and deteriorating the quality of the ideal audio wave 160. For example, frequency dependent sound's phase shift because of space distance, time delays on signal processing, stability concerns of ANC controller, non-linear characteristic of the audio speaker 125, and various usage scenarios usually need to be considered. Therefore, the residual noise 165, as a result of the destructive interference between the anti-150 noise and the weakened noise 150, is far from an ignorable one as expected. Also, the ideal audio wave 160 is in fact an ANC distorted regeneration of the audio signal 180 when feed-back control technology is utilized to improve ANC performance. As a result, the actual audio wave propagated into the people eardrum 140 deviates somewhat from the expected content of the audio signal 180. Also, people are supposed to hear more or less ANC hiss noise even after muting the audio signal 180. At the same time, from the point of view of a noise reduction system architecture, because there is only one acoustic chamber existing between the environment and the people eardrum 140, the prior art of the ANC is typically limited to have only one level of PNR generated by the headphone external structural 120 and typically only one level of ANC from ANC processor 115.

In view of the foregoing, it is clear that these traditional techniques are not perfect and leave room for more optimal approaches, especially improvement in architecture level.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 2 illustrates an exemplary ANC headphone with two physically separated acoustical chambers, where a user may put the headphone around their eardrum 203, in accordance with embodiments of the invention; and

FIG. 3 illustrates an exemplary ANC headphone in which microphones 340 may pick up and convert sound in either the noise acoustical chamber or the audio acoustical chamber or both, in accordance with embodiments of the invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. August 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”— ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide improved noise cancellation headphones. This arrangement may enable an active noise cancellation (ANC) operation against environmental noise. Some embodiments may provide a method of ANC, with two physically separated acoustic chambers. The outside located acoustic chamber may not play music and may have a vibrating diaphragm for noise cancelling purpose. The inside located acoustic chamber may play audio, may have a vibrating diaphragm for audio purpose, and may usually only feature audio playback operations but may also be used for both audio and ANC purpose. The two separated acoustic chambers may be either formed in an integrated body or formed by a combination of two bodies where each body may act as an individual device.

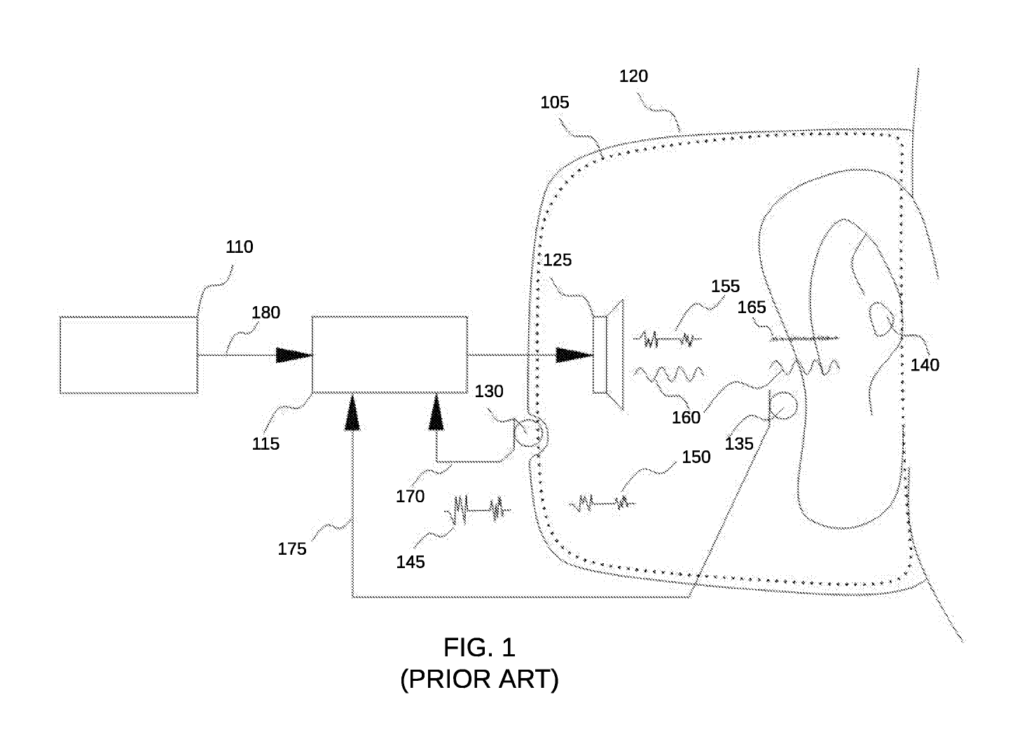

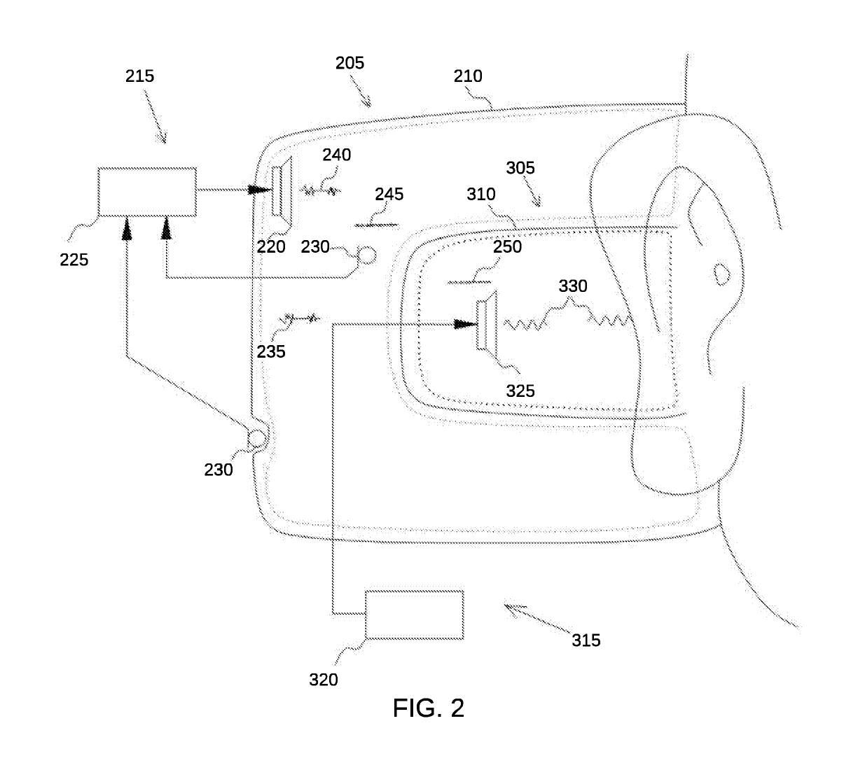

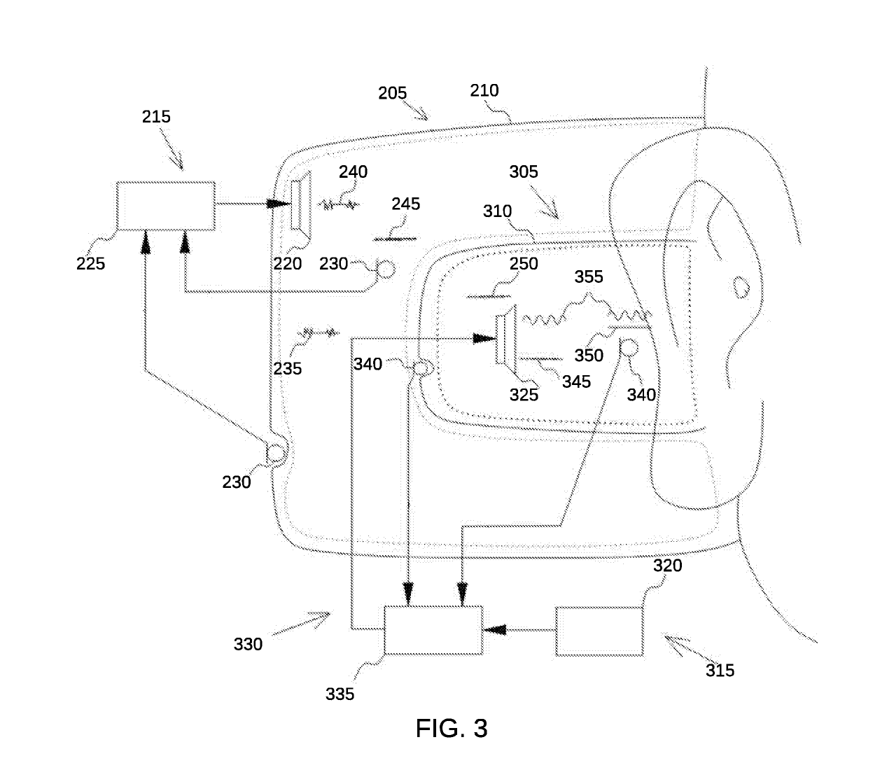

FIG. 2 illustrates an exemplary ANC headphone with two physically separated acoustical chambers, where users may put the headphone around their eardrum 203, in accordance with embodiments of the invention. In reference to FIG. 2 and FIG. 3, components that were numbered the same in FIG. 2 and FIG. 3 are meant to refer to the same component, FIG. 3 may take the processing in FIG. 2 and may apply it to an environment noisier than the environment for FIG. 2 so FIG. 3 may use the processing in FIG. 2 and add to it to make it more robust for a noisier environment. A headphone external structure or equivalent one (external_isolator) 210 may comprise of a headphone outer cover made of plastic or aluminum or other solid materials, transducer, printed circuit board, battery, sound tuning system or materials or processors, audio cable connectors, wireless signal receiver or transmitter or both of them, ear cushion, soundproofing or sound absorbing foam or other materials, and many other mechanical accessories including various kinds of supporting bracket, which may form a sealed acoustical space when people wear the headphone. In reference to FIG. 2 and FIG. 3, a headphone's inner structure or equivalent one (inner_isolator) 310 may be enclosed by external_isolator 210 and located closer to an eardrum 203, may comprise of an outer cover made of plastic or aluminum or other solid materials, transducer, printed circuit board, battery, sound tuning system or materials or processors, audio cable connectors, wireless signal receiver and processor, ear cushion, ear tip, soundproofing or sound absorbing foam or other materials, and many other mechanical accessories including various kinds of supporting bracket. The inner_isolator 310 may form a sealed acoustical space when individually put around the eardrum 203. In reference to FIG. 2 and FIG. 3, external_isolator 210, inner_isolator 310, peoplecheek or ear may form a sealed 3-dimensional space named the noise acoustical chamber 205 which is highlighted with a closed-loop broken line. The external face of the external_isolator 210 may directly contact the outside environment. In reference to FIG. 2 and FIG. 3, the inner isolator 310, and people eardrum 203 may form another sealed 3-dimensional space named the audio acoustical chamber 305 which is highlighted with a closed-loop dotted line. People eardrum 203 may contribute to part of the audio acoustical chamber 305, so people may directly hear sound in the audio acoustical chamber 305. FIG. 2 depicts two microphones 230 that may work with the noise_chamber ANC processor 225 to implement an ANC function in the noise acoustical chamber 205. The noise_chamber ANC processor 225 may be deployed inside or outside of the external_. The microphones 230 may pick up sound in either the environment or the noise acoustical chamber 205 or both and convert the sound into first sound signal. The output of microphones 230 may be connected to the input of the noise_chamber ANC processor 225. The output of the first noise cancellation processor 225 may be connected to one or more vibrating diaphragms (noise_driver) 220 used for generating anti-noise sound in the noise acoustical chamber 205. In reference to FIG. 2 and FIG. 3, the noise_driver 220 is deployed in the noise acoustical chamber 205. In reference to FIG. 2 and FIG. 3, audio receiver 320 may be deployed insides or outsides of external_and receives audio sound signal from audio player source such as phone or portable audio player via audio cable or wireless signal transmission. Also, in reference to FIG. 2 and FIG. 3, the inner_isolator 310 may be either a movable and independently constructed physical body, or a solid constructed physical body using supporting bracket to assemble together with the external isolator 210. Furthermore, in reference to FIG. 2 and FIG. 3, the inner_isolator 310 may connect with the external_isolator 210 using audio cables or wireless communication technology to exchange electrical signals and power electric. One simple example of audio cable connection comprises a detachable audio cable with connectors on one or both ends, a mating cable connector disposed in the external_, or two mating cable connectors separately disposed in the external_and the inner_isolator 310. In addition, in reference to FIG. 2 and FIG. 3, users may have flexibility to use various kinds of inner_isolator 310 or external_isolator in feature of different audio signature, ANC performance, size or shape to mate, so users could obtain various kinds of listening experience by only changing the kind of inner_isolator 310 or external_. Moreover, the external_may have much large room to accommodate large capacity battery, wireless receiver and transmitter, ANC circuits, power amplifier or EQ circuits. Those electric power or functions may be utilized by the inner_isolator 310 via the audio cables or wireless transmission connection between the inner_isolator 310 and the external_isolator 210.

For the ANC headphone illustrated in FIG. 2, the external_may function as a first-stage PNR thanks to which the environment noise may be downgraded to a weakened noise 235 after penetrating the external_isolator 210 to enter the noise acoustical chamber 205. Based on the first sound signal picked up and converted by microphones 230, the noise_chamber ANC processor 225 may implement ANC signal processing and generate the noise_chamber anti-noise sound 240 by driving the noise_driver 220. The noise_chamber anti-noise sound 240 may be of theoretical the same magnitude but 180 degrees phase difference against the weakened noise 235, so their destructive interference in the noise acoustical chamber may theoretically completely cancel each other to zero but in actual applications will generate the noise_chamber residual noise 245. Thus, after operation of the first-stage PNR and operation of the first-stage ANC, environmental noise may be downgraded to be the noise_chamber residual noise 245. Furthermore, the inner_isolator 310 may function as a second-stage PNR thanks to which the noise_chamber residual noise 245 may be further downgraded to a more weakened noise 250 after penetrating the inner_isolator 310 to enter the audio acoustical chamber 305. At the same time, the audio signal coming from the audio receiver 320 may drive the audio_driver 325 via cable connection with or without the help of wireless communication technology and generates audio wave 330 in the audio acoustical chamber 305. Because the audio signal may be processed in the audio acoustical chamber 305 and may not be processed by the noise_chamber ANC processor 225 during ANC signal processing, the audio signal may not be distorted because of ANC signal processing. In reference to FIG. 1, therefore in comparison with what happens in those headphones adopting prior art ANC technology, the example invention proposed headphone depicted in FIG. 2 adds one extra acoustical chamber in architecture to make it possible to have two physically separated acoustical chambers and use each chamber individually for the purpose of audio or active noise reduction processing to avoid the distortion of audio signal due to ANC operation. At the same time, due to the existence of one more stage PNR, the noise magnitude may be more effectively downgraded in the example invention.

FIG. 3 illustrates an exemplary ANC headphone in which microphones 340 may pick up sound in either the noise acoustical chamber 205 or the audio acoustical chamber 305 or both and convert the sound into second sound signal, in accordance with embodiments of the invention. In reference to FIG. 2 and FIG. 3, components that were numbered the same in FIG. 2 and FIG. 3 are meant to refer to the same component, FIG. 3 may take the processing in FIG. 2 and may apply it to an environment noisier than the environment for FIG. 2 so FIG. 3 may use the processing in FIG. 2 and add to it to make it more robust for a noisier environment. In reference to FIG. 3, an audio_chamber ANC processor 335 may be deployed in the insides or outsides of external_isolator . The audio_chamber ANC processor 335 may be integrated with the noise_chamber ANC processor 225 as one device or exists as an individual device. The second sound signal as the output of microphones 340 may be connected to the input of the audio_chamber ANC processor 335, as may be the output of audio receiver 320. The output of the audio_chamber ANC processor 335 may be connected to one or more vibrating diaphragms (audio_driver) 325 used for generating sound in the audio acoustical chamber 305. The audio_driver 325 may be employed in the audio acoustical chamber 305. In reference to FIG. 2 and FIG. 3, audio receiver 320 may be deployed insides or outsides of external_isolator 210.

In reference to FIG. 2 and FIG. 3, the external_isolator may function as a first-stage PNR thanks to which noise signal in environment may be downgraded to a weakened noise 235 after penetrating the external_isolator to enter into the noise acoustical chamber 205. In reference to FIG. 2 and FIG. 3, based on the first sound signal transduced by microphones 230, the noise_chamber ANC processor 225 may implement ANC signal processing and generate the noise_chamber anti-noise 240 by driving the noise_driver 220. In reference to FIG. 2 and FIG. 3, the noise_chamber anti-noise 240 may be of the theoretical same magnitude but 180 degrees phase difference against the weakened noise 235, so their destructive interference in the noise acoustical chamber may theoretical completely cancel each other but in actual applications will generate the noise_chamber residual noise 245. In reference to FIG. 2 and FIG. 3, the noise_chamber residual noise 245 may be the residual noise of the environmental noise in the noise acoustical chamber after dual operation of the first-stage PNR and the first-stage ANC. In reference to FIG. 2 and FIG. 3, the inner_isolator 310 may function as a second-stage PNR thanks to which the noise_chamber residual noise 245 may be downgraded to a more weakened noise 250 after penetrating the inner_isolator 310 to enter into the audio acoustical chamber 305. In reference to FIG. 3, the microphones 340 may pick up the noise_chamber residual noise 245 or the sound in the audio acoustical chamber 305 or both of them and convert the sound into second sound signal, then the audio_chamber ANC processor 335 may use the second sound signal and the output of the audio receiver 320 to implement another individual second-stage ANC signal processing and generate second ANC output signal as the input signal of the audio_driver 325. The audio_driver 325 transduces the second ANC output signal into both audio_chamber anti-noise 345 and second ideal audio wave 355. In reference to FIG. 3, the audio_chamber anti-noise 345 may be of the theoretical same magnitude but 180 degrees phase difference against the more weakened noise 250, so a destructive interference between 345 and 250 may be present in the audio acoustical chamber and will theoretical completely cancel each other but actually generate the audio_chamber residual noise 350 as a result. The audio_chamber residual noise 350 may be the residual noise in the audio acoustical chamber after implementing the second-stage ANC oepration. Finally, the combination of the audio_chamber residual noise 350 and the ideal audio wave 355 may arrive at the eardrum 203 and be heard by people. Therefore, environment noise in FIG. 3 overall may be downgraded four times by two stages of PNR process and two stages of ANC process before it arrives at the eardrum 203 and heard by people. In reference to prior art FIG. 1, in comparison with those ANC headphones with prior art ANC technology, the example invention proposed headphone depicted in FIG. 3 may produce significantly better noise reduction capability. At the same time, similar to prior art FIG. 1, the output of the audio receiver 320 may be distorted by second-stage ANC signal processing in the audio_chamber ANC processor 335, so the ideal audio wave 355 may be different from an ideal regeneration of the output of the audio receiver 320. However, in reference to FIG. 1 and FIG. 3, the more weakened noise 250 in the audio acoustical chamber 305 may be significantly smaller in magnitude than the weakened noise 150 in FIG. 1 (or 235 in FIG. 3) and also present different frequency spectrum after experiencing through one-stage ANC process in the noise acoustical chamber 205 and one-stage PNR process when penetrating through the inner_isolator 310. Therefore, in reference to prior art FIG. 1, in comparison with those ANC headphones with prior art ANC technology, the example invention proposed headphone depicted in FIG. 3 may use a more modestly tuning ANC algorithm and process to effectively reduce the distortion to the output of the audio receiver 320. In sum, in reference to FIG. 1 and FIG. 3, in comparison with those ANC headphones with prior art ANC technology, the example invention proposed headphone depicted in FIG. 3 adds one extra acoustical chamber in ANC architecture to make it possible to construct one more stage of PNR and one more stage of ANC so the magnitude of environment noise may be significantly reduced and the distortion to the audio signal may be better controlled.

The example invention proposed headphone depicted in FIG. 2 and FIG. 3 may coexist in one apparatus by selecting various kinds of usage modes. For example, the example invention proposed headphone depicted in FIG. 2 may be provided in one apparatus and implements when one kind of usage mode named “pure audio” is activated; Meanwhile, in the same apparatus, after switching the input of audio_driver 325 from the output of audio receiver 320 to the output of the audio_chamber ANC processor 335, another kind of usage mode named “deep ANC” is available and the apparatus may work as depicted in FIG. 3.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing headphones according to the present invention will be apparent to those skilled in the art. Various aspects of the invention have been described above by way of illustration, and the specific embodiments disclosed are not intended to limit the invention to the particular forms disclosed. The particular implementation of the headphones may vary depending upon the particular context or application. By way of example, and not limitation, the headphones described in the foregoing were principally directed to headphone noise cancellation using active and passive noise cancellation implementations; however, similar techniques may instead be applied to speakers in general, phone ear pieces, headsets, microphones, musical instruments, safety helmet speakers/headphones, motorcycle helmet speakers/headphones, sleeping aid headphones, virtual reality headsets or goggles, sports helmets, pilot helmets or headsets, gaming headsets, telephone operator helmets or headsets, driver helmets or headsets, headphones integrated into headwear in general, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. An apparatus comprising:
a noise acoustical chamber implement, said noise acoustical chamber comprises a first chamber that is configured to form a first generally sealed space;
a headphone external structure, said headphone external structure is configured to enclose said first chamber;
first chamber microphones, said first chamber microphones are configured to pick up and converter environment sound or noise in said noise acoustical chamber into noise signal;
a first processor, said first processor comprises an input that is configured to receive said noise signal, wherein said first processor is configured to implement first-stage active noise cancellation (ANC) signal processing to said noise signal and generate first anti-noise signal to be the input of said noise driver;
a noise driver mechanism, said noise driver is configured to receive said first anti-noise signal of said first processor, wherein said noise driver comprises one or more vibratable audio diaphragms operable for generating a first anti-noise sound wave based on said output of said first processor; and
in which said headphone external structure comprises an external_isolator configured as a first-stage passive noise reduction (PNR) operable for downgrading said environment sound to at least one of, a downgraded, a weakened and a residual noise in said noise acoustical chamber.

2. The apparatus in accordance with claim 1, wherein said first chamber microphones comprises at least one or more microphones.

3. The apparatus in accordance with claim 2, wherein said first anti-noise sound wave is configured to substantially reduce said noise in said noise acoustical chamber to at least one of, a downgraded, a weakened and a residual noise in said noise acoustical chamber.

4. The apparatus in accordance with claim 3, further comprising an audio acoustical chamber implement, said audio acoustical chamber implement comprises an inner structure to form a second chamber that is configured to form a second generally sealed space around people eardrum so said people eardrum is acoustically isolated and a second-stage PNR operable for downgrading said residual noise in said noise acoustical chamber to at least one of, a downgraded, a weakened and a residual noise in said audio acoustical chamber.

5. The apparatus in accordance with claim 4, wherein said inner_isolator is either a movable and individually constructed physical body, or a component with supporting bracket to be assembled together with said external_isolator.

6. The apparatus in accordance with claim 5, wherein said inner_isolator and said external_isolator are connected using audio cables or wireless communication technology to exchange electrical signals and power electric.

7. The apparatus in accordance with claim 6, wherein said external_isolator may have much large room to accommodate large capacity battery, wireless receiver and transmitter, ANC circuits, power amplifier or EQ circuits so that those said electric power or said functions may be utilized by said inner_isolator via said audio cables or said wireless communication technology between the said inner_isolator and the said external_isolator.

8. The apparatus in accordance with claim 7, wherein said audio cables between said external_isolator and said inner_isolator may comprise a detachable audio cable with connectors on one or both ends, a mating cable connector disposed in said external_isolator or two mating cable connectors separately disposed in said external_isolator and said inner_isolator.

9. The apparatus in accordance with claim 8, further comprising an audio driver mechanism, said audio driver is deployed in said inner_isolator and is configured to generate sound wave in said audio acoustical chamber from said audio signal, wherein said audio driver comprises one or more vibratable audio diaphragms operable for generating said sound wave based on said audio signal.

10. The apparatus in accordance with claim 9, wherein said first-stage ANC signal processing is excluded from processing of said audio signal to avoid said people eardrum hearing a distortion of said audio signal due to said first-stage ANC signal processing.

11. The apparatus in accordance with claim 10, wherein said first-stage ANC, said first-stage PNR, and said second-stage PNR work together to significantly downgrade the impact of said environment sound on said sound wave in said audio acoustical chamber and provide said people eardrum a very quiet listening condition.

12. The apparatus in accordance with claim 8, further comprising second chamber microphones, wherein said second chamber microphones are configured to pick up and convert sound wave in said audio acoustical chamber into second sound signal.

13. The apparatus in accordance with claim 12, further comprising a second-stage ANC mechanism, said second-stage ANC is implemented by a second processor or said first processor, and said second-stage ANC is configured to generate second ANC output signal from said audio signal and said second sound signal.

14. The apparatus in accordance with claim 13, further comprising an audio driver mechanism, said audio driver is deployed in said inner_isolator and is configured to generate sound in said acoustical audio chamber from transducing said second ANC output signal, wherein said audio driver comprises one or more vibratable audio diaphragms operable.

15. The apparatus in accordance with claim 14, wherein said sound generated by said audio driver comprises audio_chamber anti-noise to substantially reduce noise in said audio acoustical chamber to at least one of, a downgraded, a weakened and a residual noise in said audio acoustical chamber.

16. The apparatus in accordance with claim 15, wherein said first-stage ANC, said second-stage ANC, said first-stage PNR, said second-stage PNR work together to substantially downgrade the impact of said environment sound on said audio wave in said audio acoustical chamber and provide said people eardrum a much quieter listening condition.

17. The apparatus in accordance with claim 16, wherein there may be a switch mechanism to change said audio driver's input signal from said second ANC output signal to said audio signal to remove said second-stage ANC's distortion effect on the said audio wave in the said audio acoustical chamber.

18. An apparatus comprising:
means for forming a first generally sealed space;
means for enclosing said first generally sealed space and forming first-stage PNR;
means for picking up and converting environment sound or noise in said first generally sealed space into noise signal;
means for implementing ANC signal processing to said noise signal;
means for generating a first anti-noise signal based on said noise signal;
means for utilizing one or more vibrating diaphragms to transduce said first anti-noise signal into first anti-noise sound in said first generally sealed space, wherein forms ANC and said noise is generally reduced to be at least one of, a downgraded, a weakened and a residual noise signal in said first generally sealed space
means for forming a second generally sealed space around people eardrum;
means for enclosing said second generally sealed space in said first generally sealed space and forming second-stage PNR;
means for utilizing audio cables or wireless communication technology to build up connection to exchange electrical signals and power electric between enclosure of said first generally sealed space and enclosure of said second generally sealed space;
means for provide flexibility to individually replace said enclosures of said first generally sealed space or said second generally sealed space;
means for accommodating large capacity battery, wireless receiver and transmitter, ANC circuits, power amplifier or EQ circuits in said enclosure of said first generally sealed space to support functions implemented in said enclosure of said second generally sealed space;
means for receiving audio signal coming from user's audio player source; and
means for utilizing separate one or more vibrating diaphragms to transduce said audio signal into audio sound in said second generally sealed space, wherein said ANC signal processing of said noise signal is excluded from processing of said audio signal to avoid a distortion of said audio signal due to said ANC signal processing.

19. An apparatus comprising:
means for forming a first generally sealed space;
means for enclosing said first generally sealed space and forming first-stage PNR;
means for picking up and converting environment sound or noise in said first generally sealed space into noise signal;
means for implementing ANC signal processing to said noise signal;
means for generating a first anti-noise signal based on said noise signal;
means for utilizing one or more vibrating diaphragms to transduce said first anti-noise signal into first anti-noise sound in said first generally sealed space, wherein forms first-stage ANC and said noise is generally reduced to be at least one of, a downgraded, a weakened and a residual noise signal in said first generally sealed space.
means for forming a second generally sealed space around people eardrum;
means for enclosing said second generally sealed space in said first generally sealed space and forming second-stage PNR;
means for utilizing audio cables or wireless communication technology to build up connection to exchange electrical signals and power electric between enclosure of said first generally sealed space and enclosure of said second generally sealed space;
means for provide flexibility to individually replace said enclosures of said first generally sealed space or said second generally sealed space;
means for accommodating large capacity battery, wireless receiver and transmitter, ANC circuits, power amplifier or EQ circuits in said enclosure of said first generally sealed space to support functions implemented in said enclosure of said second generally sealed space;
means for picking up and converting noise in said first generally sealed space or in said second generally sealed space into second noise signal;
means for receiving audio signal coming from user's audio player source;
means for implementing second-stage ANC signal processing to said second noise signal and said audio signal;
means for generating second ANC output signal from second-stage ANC signal processing;
means for utilizing separate one or more vibrating diaphragms to transduce said second ANC output signal into audio sound and second anti-noise sound in said second generally sealed space, wherein forms second-stage ANC and said second anti-noise sound generally cancel noise in said second generally sealed space to produce at least one of, a downgraded, a weakened and a residual noise signal in said second generally sealed space; and
means for a switch mechanism to switch input of said diaphragms in said second generally sealed space from said second ANC output signal to said audio signal;
